(19) United States
(12) Patent Application Publication
(10) Pub. No.: US 2019/0005196 A1
(43) Pub. Date: Jan. 3, 2019

(54) ACCESS RIGHTS DETERMINATION BY PROXY DATA

(71) Applicant: Nuance Communications, Inc., Burlington, MA (US)

(72) Inventors: Andreas Neubacher, Vienna (AT); Matthias Helletzgruber, Vienna (AT); Peter Ungar, Budapest (HU); Gyorgy Szitnyai, Budapest (HU)

(21) Appl. No.: 15/637,437

(22) Filed: Jun. 29, 2017

(51) Int. Cl. G06F 19/00; G06F 21/62; G06Q 50/22; G06Q 10/10

(52) U.S. Cl. CPC G06F 19/322; G06Q 10/10; G06Q 50/22; G06F 21/6245

(57) ABSTRACT

Data access rights are validated by using data proxies, so that providers of services such as speech recognition are not required to know the identity and access rights of users. The need for keeping user accounts and associated data access rights synchronized between systems such as hospital active directory systems, Electronic Health Record/Electronic Medical Record (EHR/EMR) systems, and speech recognition systems is, therefore, removed. Access rights are determined using proxy data, in order to provide access to confidential data, based on the provision of the proxy data in place of user credentials. Secure access to Protected Health Information (PHI) and other confidential data is guaranteed without having to provide the user credentials, because ownership of the data provided as proxy data is equivalent to presence of access rights to the proxied data.

### BACKGROUND

Data security, especially access control, is essential for product acceptance by customers of software services, such as hospitals and doctors, in fields such as healthcare. Such access control involves restricting access to personal private information, such as Protected Health Information (PHI). Software products that host data on servers for use in healthcare and other fields must, therefore, ensure that data hosted on the servers is accessible only to users that have appropriate rights. However, hospitals frequently implement complex role-based access rights systems, for example access rights systems that are related to resident-attending workflows or Quality Assurance (QA) workflows for transcription. Also, hospitals frequently deploy a multitude of different software products that need to manage patient and user data. Therefore, it is difficult for all of these software products to implement appropriate security and access control in such settings without creating high overhead for users and administrators.

### SUMMARY

In accordance with an embodiment of the invention, data access rights are validated by using data proxies, so that providers of services such as speech recognition are not required to know the identity and access rights of users. The need for keeping user accounts and associated data access rights synchronized between systems such as hospital active directory systems, Electronic Health Record/Electronic Medical Record (EHR/EMR) systems, and speech recognition systems is, therefore, removed. Access rights are determined using proxy data, in order to provide access to confidential data, based on the provision of the proxy data in place of user credentials. Secure access to Protected Health Information (PHI) and other confidential data is guaranteed without having to provide the user credentials, because ownership of the data provided as proxy data is equivalent to presence of access rights to the proxied data.

In one embodiment according to the invention, there is provided a computer-implemented method for access rights determination. The computer-implemented method comprises receiving proxy data used as user credentials to access confidential data, the confidential data having a restricted access level; and determining whether the proxy data has an equivalent or greater restricted access level as compared with the restricted access level of the confidential data. Upon determining that the proxy data does have an equivalent or greater restricted access level as compared with the restricted access level of the confidential data, access is provided to the confidential data.

In further, related embodiments, the determining may comprise determining whether the proxy data is: (i) substantially equivalent in restricted access level by virtue of being the result of a computer-implemented transformation of the confidential data; or (ii) greater in restricted access level by virtue of being data from which the confidential data is derived by a computer-implemented process; or (iii) substantially equivalent or greater in restricted access level based on business rules or by law. The confidential data may comprise audio data comprising speech, and the proxy data may comprise speech recognition text derived from the audio data. The audio data may comprise speech comprising personal health information or personal medical information, and the speech recognition text may comprise speech recognition data of an electronic health record or electronic medical record, derived from the audio data. Receiving the proxy data may comprise receiving an application layer level communication from an electronic health record system or electronic medical record system to determine access rights to the confidential data, and the confidential data may be stored by a speech recognition system.

In other, related embodiments, the confidential data may comprise personal health information or personal medical information, and the proxy data may comprise data from which the confidential data is derived by a clinical language understanding engine. The confidential data may comprise personal health information or personal medical information comprising, for example: data associated with identification of a medical problem; a medical treatment; or a medication; and the proxy data may comprise (i) sufficient confidential data identifying a person associated with a medical report of the person to permit access to the medical report; and (ii) at least a portion of a text of the medical report of the person that is at an equivalent or greater restricted access level as the confidential data. Receiving the proxy data may comprise receiving an application layer level communication from a first system to a second system, different from the first system, to determine access rights to the confidential data stored by the second system. The proxy data may be accessible to a user, the user being a user of the first system, based on at least (i) credentials of the user with the first system and (ii) access rights of the user with the first system; and the providing access to the confidential data may comprise using the proxy data as user credentials to permit the user of the first system to access the confidential data stored by the second system. The method may further comprise, based on the determining that the proxy data does have an equivalent or greater restricted access level as compared with the restricted access level of the confidential data, providing rights to the access to the confidential data to a user, for the duration of a session of interaction with the user. The providing the rights to the access to the confidential data may be performed as a temporary state for the duration of the session.

In another embodiment according to the invention, there is provided a computer system comprising: a processor; and a memory with computer code instructions stored thereon. The processor and the memory, with the computer code instructions are configured to implement: an access rights control module, the access rights control module being configured to receive proxy data used as user credentials to access confidential data, the confidential data having a restricted access level; and a proxy data assessment module, the proxy data assessment module being configured to determine whether the proxy data has an equivalent or greater restricted access level as compared with the restricted access level of the confidential data. The access rights control module is further configured, upon a determination by the proxy data assessment module that the proxy data does have an equivalent or greater restricted access level as compared with the restricted access level of the confidential data, to provide access to the confidential data.

In further related embodiments, the proxy data assessment module may be further configured to determine whether the proxy data is: (i) substantially equivalent in restricted access level by virtue of being the result of a computer-implemented transformation of the confidential data; or (ii) greater in restricted access level by virtue of being data from which the confidential data is derived by a computer-implemented process; or (iii) substantially equivalent or greater in restricted access level based on business rules or by law. The confidential data may comprise audio data comprising speech, and the proxy data may comprise speech recognition text derived from the audio data. The proxy data assessment module may be further configured to determine whether the proxy data has an equivalent or greater restricted access level as compared with the restricted access level of the confidential data based on confirming whether the proxy data does in fact comprise speech recognition text that is derived from the audio data. The audio data may comprise speech comprising personal health information or personal medical information, and the speech recognition text may comprise speech recognition data of an electronic health record or electronic medical record, derived from the audio data. The access rights control module may be further configured to receive the proxy data by receiving an application layer level communication from an electronic health record system or electronic medical record system to determine access rights to the confidential data, and the confidential data may be stored by a speech recognition system.

In further related embodiments, the confidential data may comprise personal health information or personal medical information, and the proxy data may comprise data from which the confidential data is derived by a clinical language understanding engine. The proxy data assessment module may be further configured to determine whether the proxy data has an equivalent or greater restricted access level as compared with the restricted access level of the confidential data based on confirming whether the proxy data does in fact comprise data from which the confidential data is derived by a clinical language understanding engine. The confidential data may comprise personal health information or personal medical information comprising at least one of: data associated with identification of a medical problem; a medical treatment; and a medication; and the proxy data may comprise: (i) sufficient confidential data identifying a person associated with a medical report of the person to permit access to the medical report; and (ii) at least a portion of a text of the medical report of the person that is at an equivalent or greater restricted access level as the confidential data. The proxy data assessment module may be further configured to determine whether the proxy data has an equivalent or greater restricted access level as compared with the restricted access level of the confidential data based on confirming whether the proxy data does in fact comprise: (i) sufficient confidential data identifying a person associated with a medical report of the person to permit access to the medical report; and (ii) text of the medical report of the person.

In further related embodiments, the access rights control module may be further configured to receive the proxy data by receiving an application layer level communication from a first system to a second system, different from the first system, to determine access rights to the confidential data stored by the second system. The proxy data may be accessible to a user, the user being a user of the first system, based on at least (i) credentials of the user with the first system and (ii) access rights of the user with the first system. The access rights control module may be further configured, upon the determination by the proxy data assessment module that the proxy data does have an equivalent or greater restricted access level as compared with the restricted access level of the confidential data, to use the proxy data as user credentials to permit the user of the first system to access the confidential data stored by the second system. The system may comprise a session control module, the session control module being configured, upon the determination by the proxy data assessment module that the proxy data does have an equivalent or greater restricted access level as compared with the restricted access level of the confidential data, to provide rights to the access to the confidential data to a user, for the duration of a session of interaction with the user.

In another embodiment according to the invention, there is provided a non-transitory computer-readable medium configured to store instructions for access rights determination, the instructions, when loaded and executed by a processor, cause the processor to determine access rights by: receiving proxy data used as user credentials to access confidential data, the confidential data having a restricted access level; determining whether the proxy data has an equivalent or greater restricted access level as compared with the restricted access level of the confidential data; and upon determining that the proxy data does have an equivalent or greater restricted access level as compared with the restricted access level of the confidential data, providing access to the confidential data.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic block diagram illustrating an example of a conventional deferred correction workflow in the healthcare field.

FIG. 2 is a schematic block diagram of a system for access rights determination using proxy data, in accordance with an embodiment of the invention.

FIG. 3 is a schematic block diagram of a proxy data assessment module, in accordance with an embodiment of the invention.

FIG. 4 is a schematic block diagram of a system for access rights determination using proxy data, in communication with an electronic health record or electronic medical record system and a speech recognition system, in accordance with an embodiment of the invention.

FIG. 5 is a schematic block diagram of a system for access rights determination using proxy data, which includes a session control module, in accordance with an embodiment of the invention.

FIG. 6 is a schematic block diagram of a system for access rights determination using proxy data, in communication with first system requiring user credentials and access rights, and a second system on which confidential data is stored, in accordance with an embodiment of the invention.

FIG. 7 is a schematic block diagram of a computer-implemented method for access rights determination in accordance with an embodiment of the invention.

FIG. 8 illustrates a computer network or similar digital processing environment in which embodiments of the present invention may be implemented.

FIG. 9 is a diagram of an example internal structure of a computer (e.g., client processor/device or server computers) in the computer system of FIG. 8.

### DETAILED DESCRIPTION

A description of example embodiments follows.

In conventional systems, access rights typically require: 1) a check for user credentials, to verify the identity of the person communicating with the system, and 2) a check for user roles or rights, to verify the identified person's right to access a specific data item. However, setting up such access rights in a multi-company deployment, for example involving a hospital system, an Electronic Health Record/Electronic Medical Record (EHR/EMIR) vendor system and a speech recognition service, is typically cumbersome and error prone. Thus, it is not easy to ensure that hospital-configured access rights match those known to software providers, such as those providing the speech recognition service.

In accordance with an embodiment of the invention, data access rights are validated by using data proxies, so that providers of services such as speech recognition are not required to know the identity and access rights of users. By removing the need for keeping user accounts and associated data access rights synchronized between hospital active directory systems, EHR/EMIR systems, and speech recognition systems, an embodiment according to the invention can provide a number of advantages. In particular, an embodiment according to the invention can significantly reduce administrative overhead; allow instantaneous deployment and new customer enrollment; and eliminate access rights mismatch, and, thus, minimize risks related to violation of Protected Health Information (PHI) data access restrictions. For example, such PHI data access restrictions may include those required by the U.S. Health Insurance Portability and Accountability Act of 1996 (HIPAA) and associated laws and regulations, for instance those requirements found in the U.S. Code of Federal Regulations at 45 CFR Part 160 and Subparts A and C of Part 164, and similar related requirements in the United States and other countries.

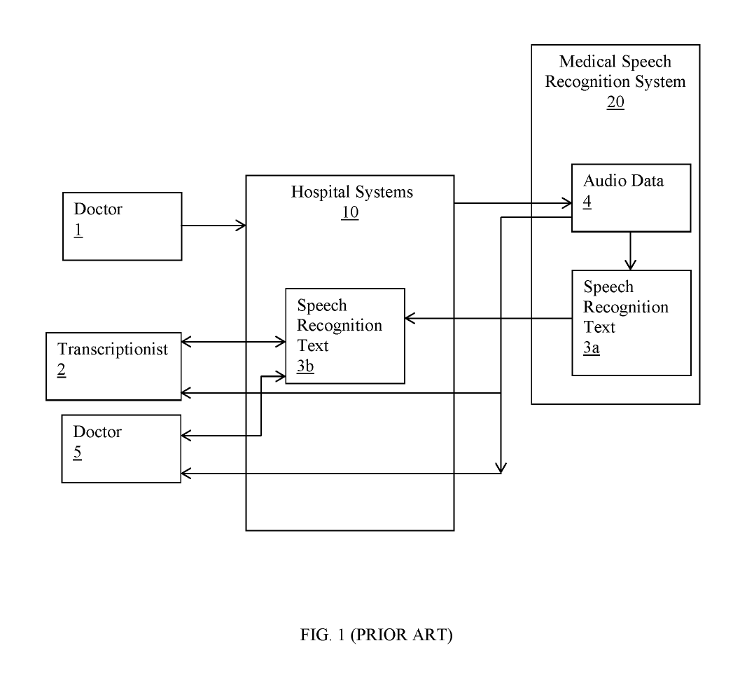

FIG. 1 is a schematic block diagram illustrating an example of a conventional deferred correction workflow in the healthcare field. A document, such as an electronic medical record, is dictated via speech recognition by a doctor, 1, but not finalized. The doctor 1 is a user of a hospital computer system 10. The dictation by the doctor 1 is transmitted over a network to a medical speech recognition system 20, which is a separate computer system from the hospital system computer system 10. The medical speech recognition system 20 produces a speech recognition text 3a, out of the audio data 4, as a result of a computer-implemented speech recognition process. The medical speech recognition server 20 stores both the audio data 4 of the doctor's dictation, and the speech recognition text 3a that is derived from it. The speech recognition text 3b is also returned to the hospital system 10. As part of the deferred correction workflow, a transcriptionist, 2, for example, a hospital employee, subsequently corrects errors in the speech recognition 3b, by listening to the audio 4 of the dictation by the doctor 1, and revising the received speech recognition text 3b accordingly. The final report is then reviewed by another doctor 5. The software applications used in each of those steps—that is, the applications used or accessed by the doctor 1, the transcriptionist 2, the doctor 5 and the medical speech recognition system 20, may be different third party software systems that communicate with each other via messages using a protocol, such as the HL7 protocol (discussed further below). In each of the foregoing steps, speech recognition and bouncing-ball-playback is managed by the medical speech recognition system 20.

However, in the conventional workflow of FIG. 1, a problem emerges, which is solved by an embodiment according to the present invention: namely, the question of how the medical speech recognition system 20 can know whether users, such as the transcriptionist 2 and the second doctor 5, are allowed to listen in on the audio 4, such as the dictation by the doctor 1, that is associated with a medical report, without having full access to the user identity and access rights databases that are used by all involved in the hospital applications on the hospital computer system 10. Here, it is noted that not all users of the hospital computer system have the rights to access the speech recognition text 3b, the medical report, or the audio data 4. Furthermore, while the hospital systems can provide access to the speech recognition text 3b, access to audio data 4 can only be provided by the medical speech recognition system 20.

By contrast with the conventional workflow of FIG. 1, an embodiment according to the present invention provides for access rights determination using proxy data, as will be illustrated further below. A brief example to illustrate use of an embodiment of the invention is as follows. First, from the point of privacy, it is clear that the dictating doctor 1, is allowed to see the speech recognition results 3a/3b based on those results being the dictating user (i.e., doctor) l's own audio. Thus, no user rights management is required. The outcome of this step is text 3a and audio 4, both of which are stored on the medical speech recognition servers 20, and text 3b, which is stored in the hospital system 10. Next, an embodiment according to the invention utilizes the recognition that it is sufficient, for access rights purposes, for the medical speech recognition system 20 to know that the users, 2 and 5, have access to the speech recognition text 3b, in order to provide those users with access to the audio data 4 upon which the speech recognition text was based. Based on this, an embodiment according to the invention requires the hospital application to present the speech recognition text 3b itself to the medical speech recognition server 20, in lieu of presenting user credentials. An embodiment according to the invention recognizes that any user that is allowed to read the speech recognition text 3b must also be allowed to listen to the sound that was the source of the text, namely, the audio data 4 associated with the medical report. Thus, there is no need for further validation of credentials and access rights, if the text itself 3b is presented as proxy data for the access rights determination.

An embodiment according to the invention therefore relates, more generally, to access rights determination using proxy data, in order to provide access to confidential data that is related to the proxy data, or confidential data that is derived from the proxy data, based on the provision of the proxy data in place of user credentials. Secure access to Protected Health Information (PHI) is guaranteed without having to provide the user credentials, because ownership of the data provided as proxy data is equivalent to presence of access rights to that data.

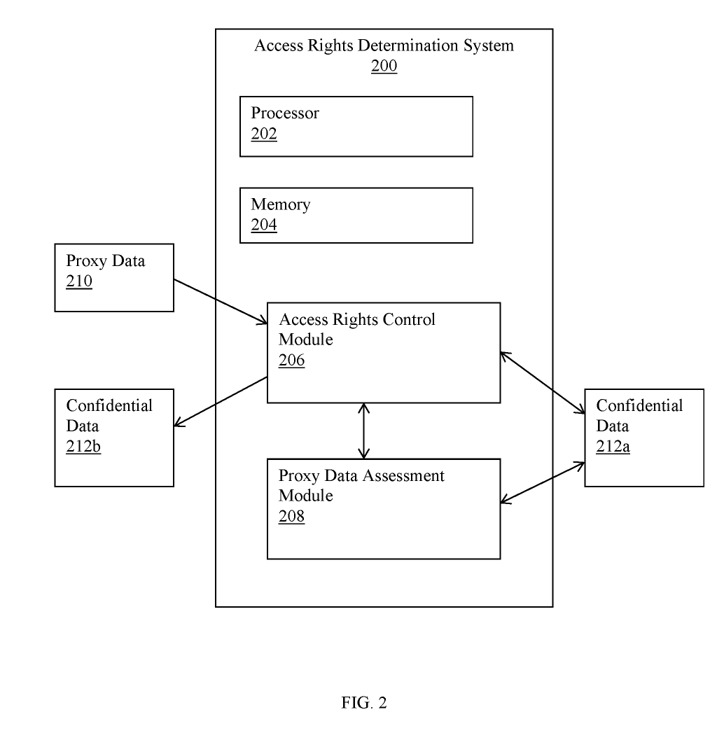

FIG. 2 is a schematic block diagram of a computer system 200 for access rights determination using proxy data, in accordance with an embodiment of the invention. The system 200 includes a processor 202, and a memory 204 with computer code instructions stored thereon. The processor 202 and the memory 204, with the computer code instructions, are configured to implement an access rights control module 206 and a proxy data assessment module 208. The access rights control module 206 is configured to receive proxy data 210 used as user credentials to access confidential data 212a, which has a certain restricted access level. In one example, with reference to both FIGS. 1 and 2, the confidential data 212a may be the audio data 4 of a dictation of a doctor 1, related to the person's personal health information or personal medical information; and the proxy data 210 may be the speech recognition text 3b that is based on the audio data 4. The proxy data assessment module 208 is configured to determine whether the proxy data 210 has an equivalent or greater restricted access level as compared with the restricted access level of the confidential data 212a. For example, the proxy data assessment module 208 may determine that the speech recognition text 3b has an equivalent restricted access level as compared with the restricted access level of the audio data 4. The access rights control module 206 is further configured, upon a determination by the proxy data assessment module 208 that the proxy data does 210 have an equivalent or greater restricted access level as compared with the restricted access level of the confidential data 212a, to provide access to the confidential data 212a. For example, the access rights control module 206 may provide access to audio data 4 based on the determination by the proxy data assessment module 208.

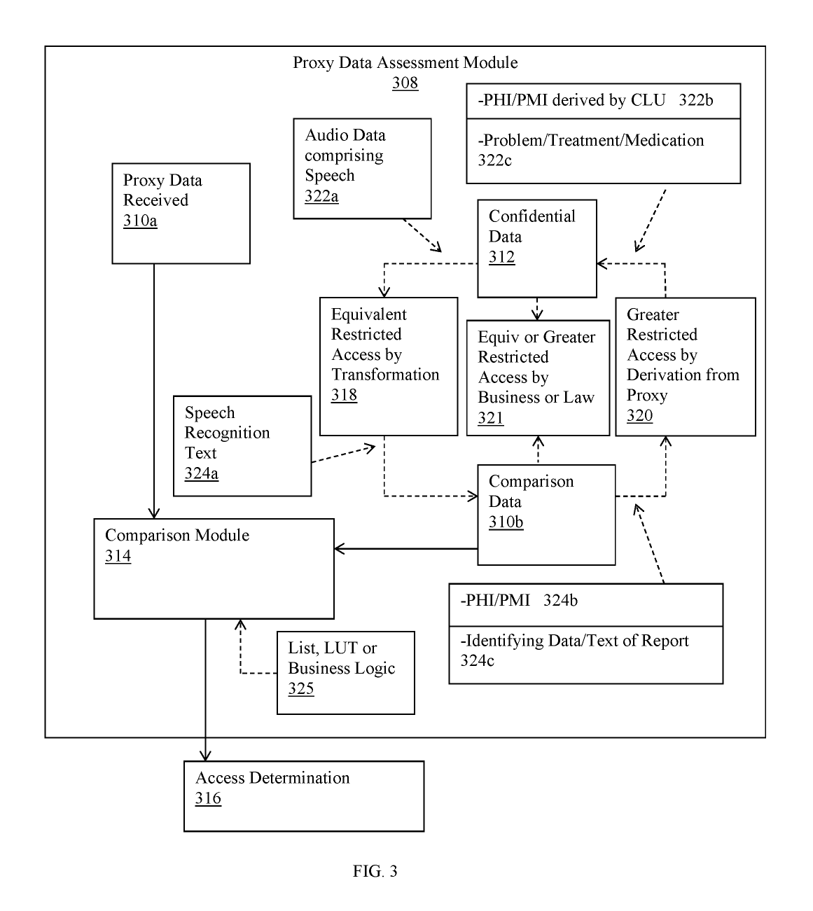

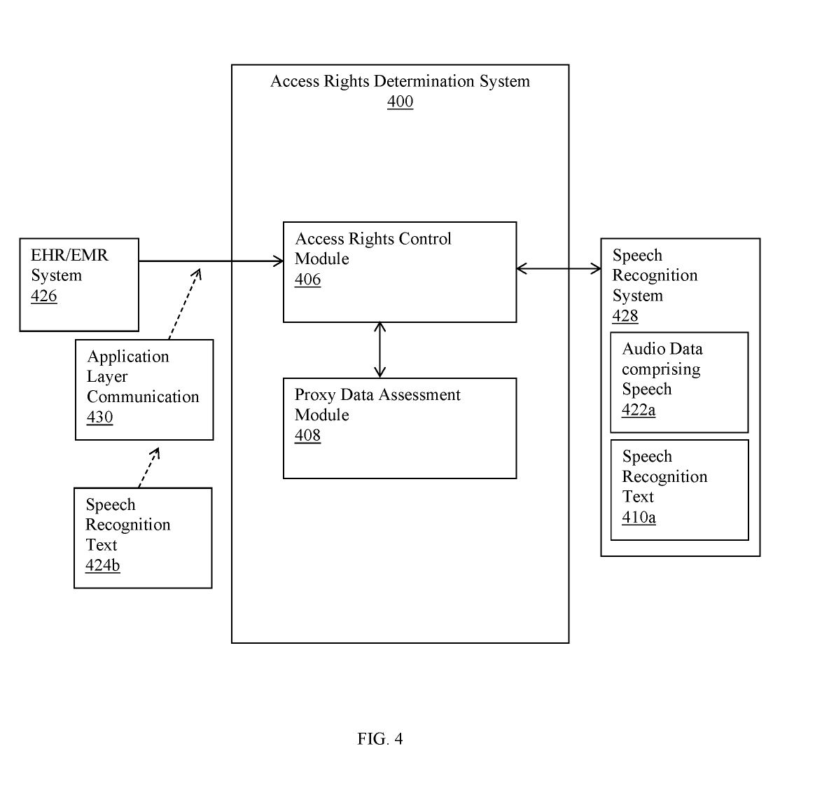

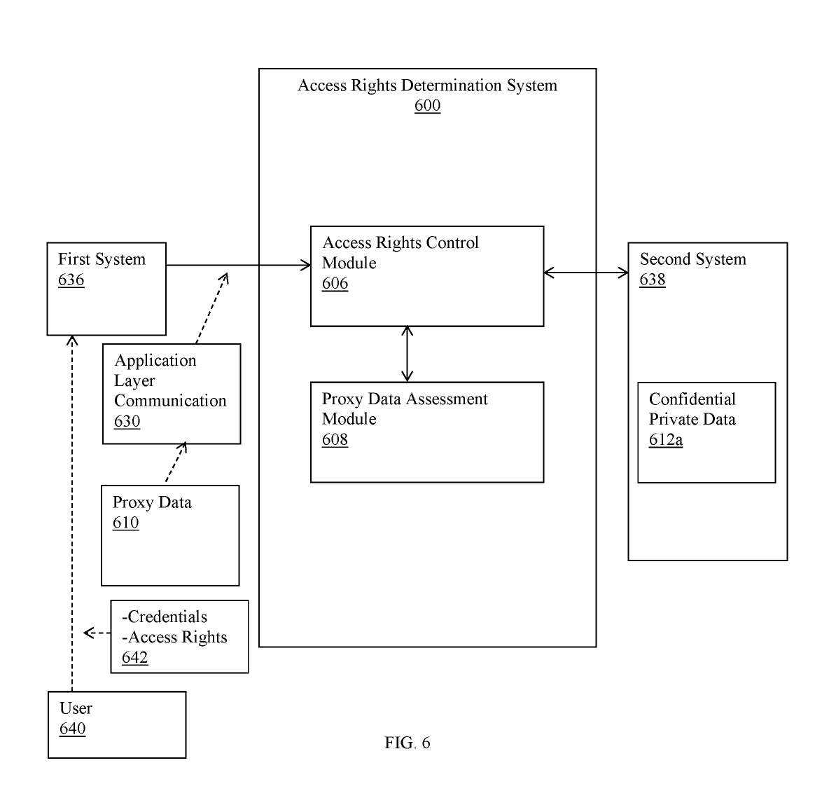

FIG. 3 is a schematic block diagram of a proxy data assessment module 308, in accordance with an embodiment of the invention, which may, for example, serve as the proxy data assessment module 208 of FIG. 2. The proxy data assessment module 308 receives proxy data 310a. The proxy data assessment module 308 can receive the proxy data 310a, for example, from access rights control module 206 (see FIG. 2), which can, in turn, receive the proxy data 210 from a system external to the access rights determination system 200 (see FIG. 2), for example, from an EHR/EMR system 426 (see FIG. 4) or from a first system 636 (see FIG. 6). Alternatively, the proxy data assessment module 308 can receive the proxy data 310a directly from such a system external to the access rights determination system 200 (see FIG. 2), such as from the EHR/EMR system 426 (see FIG. 4) or first system 636 (see FIG. 6). The proxy data assessment module 308 is configured to determine whether received proxy data 310a is: (i) substantially equivalent 318 in restricted access level by virtue of being the result of a computer-implemented transformation of confidential data 312; or (ii) greater in restricted access level 320 by virtue of being data from which confidential data 312 is derived by a computer-implemented process; or (iii) substantially equivalent or greater 321 in restricted access level based on business rules or by law.

In one example in accordance with the embodiment of FIG. 3, the confidential data 312 can comprise audio data comprising speech 322a, and the proxy data 310a can comprise speech recognition text 324a derived from the audio data. In such a case, the audio data 322a and speech recognition text 324a are considered to be substantially equivalent 318 in restricted access level by virtue of being the result of a computer-implemented transformation of the confidential data 312—here, the transformation being a speech recognition process performed on the audio data 322a. The proxy data assessment module 308 can be further configured to determine whether the proxy data 310a has an equivalent 318 or greater 320 restricted access level as compared with the restricted access level of the confidential data 312 based on confirming whether the received proxy data 310a does in fact comprise speech recognition text 324a that is derived from the audio data 322a. In one example, the audio data comprises speech 322a comprising personal health information or personal medical information, and the speech recognition text 324a comprises speech recognition data of an electronic health record or electronic medical record, derived from the audio data 322a.

In another example in accordance with the embodiment of FIG. 3, the confidential data 312 can comprise personal health information or personal medical information (PHI/PMI) 322b, and the proxy data comprises PHI/PMI data 324b from which the confidential data 322b is derived by a clinical language understanding engine (CLU). The proxy data assessment module 308 can be further configured to determine whether the received proxy data 310a has an equivalent 318 or greater 320 restricted access level as compared with the restricted access level of the confidential data based on confirming whether the proxy data 310a does in fact comprise data 324b from which the confidential data 322b is derived by a clinical language understanding engine. More generally, in accordance with an embodiment of the invention, a similar solution using proxy data can be applied to data other than the audio that is associated with speech recognition data. For example, in the field of HL7 patient data, if a hospital system can present, to a server, data which only a user with access rights to that data can access, then the server can return related or derived data—such as results from a Clinical Language Understanding (CLU) engine—without having to manage user credentials. The HL7 Protocol, referred to herein, is part of a set of international standards for transfer of clinical and administrative data between software applications used by healthcare providers. The HL7 protocol focuses on Level 7 of the Open Systems Interconnection (OSI) model, which is known as the Application Layer. The OSI model is a product of the Open Systems Interconnection project at the International Organization for Standardization (ISO), maintained by the identification ISO/IEC 7498-1, the entire teachings of which are hereby incorporated herein by reference. Communications between software applications taught in accordance with an embodiment of the invention may be HL7 protocol communications, for example Medical HL7 protocol communications.

In another example in accordance with the embodiment of FIG. 3, the confidential data 312 comprises personal health information or personal medical information comprising at least one of: data associated with identification of a medical problem; a medical treatment; and a medication, 322c. Here, the proxy data 324c comprises: (i) sufficient confidential data identifying a person associated with a medical report of the person to permit access to the medical report; and (ii) at least a portion of a text of the medical report of the person 324c that is at an equivalent or greater restricted access level as the confidential data. The proxy data assessment module 308 is further configured to determine whether the proxy data 310a has an equivalent 318 or greater 320 restricted access level as compared with the restricted access level of the confidential data 312 based on confirming whether the proxy data 310a does in fact comprise: (i) sufficient confidential data identifying a person associated with a medical report of the person to permit access to the medical report; and (ii) at least a portion of a text of the medical report of the person 324c that is at an equivalent or greater restricted access level as the confidential data.

In another example in accordance with the embodiment of FIG. 3, the confidential data and the comparison data are such that their restricted access levels are related based on business rules or by law. Thus, the proxy data assessment module 308 can be further configured to determine whether the received proxy data 310a has a substantially equivalent or greater 321 restricted access level as compared with the restricted access level of the confidential data based on confirming whether the proxy data 310a does in fact comprise data having such a substantially equivalent or greater 321 restricted access level based on business rules or by law. For example, the confidential data may comprise a patient's medical history, whereas the comparison data may comprise that patient's current medication. While these types of data cannot be transformed into each other or derived from each other, they both comprise Protected Health Information according to rules such as the HIPAA privacy rules, referred to above, for example, and therefore their restricted access levels are legally equivalent. In another example, a person with access to a company's confidential financial information might implicitly have access to documents describing the company's confidential business strategy, even though strategy and financial data cannot be derived from each other or transformed into each other.

In the embodiment of FIG. 3, each of the above determinations by the proxy data assessment module 308, that the received proxy data 310a does indeed comprise an equivalent 318 or greater 320 restricted access level, are performed by comparison module 314. In one example, this comparison module 314 compares speech recognition text 324a, which has been provided as proxy data 310a for the purpose of user credentials, with stored speech recognition text 3a (see FIG. 1) that is already present on a medical speech recognition server as a result of a speech recognition transformation of audio data comprising speech 322a. For example, either an identical match of speech recognition text 324a with such stored speech recognition text, or in some cases, a sufficiently close match with authorized minor errors, may be found by the comparison module 314—or a lack of such a match. The comparison may be performed on a sufficiently large fraction (such as less than a quarter, or less than a tenth, or less than 1%) of the speech recognition text or other proxy data. This information on whether there is a sufficient match is then used by the proxy data assessment module 308 to determine whether the proxy data 310a has an equivalent or greater restricted access level, that is, if a match is found. In another example, the comparison module 314 can compare the PHI/PMI 324b with PHI/PMI that is already stored on a medical server, or can compare the identifying data and the at least a portion of the text of the medical report 324c with such data found in a stored medical report on the medical server. If the comparison module 314 finds that such information matches identically, or, in some cases, with authorized minor errors, the proxy data assessment module 308 can determine that the proxy data 310a has an equivalent or greater restricted access level. In any of the above cases, the output of the comparison module 314 is provided to access determination module 316, which either (i) provides a determination that access should be granted to the confidential data 312, if a match or authorized sufficiently close match is found, or (ii) provides a determination that such access should not be granted. In another example, the comparison module 314 can confirm whether the proxy data 310a does in fact comprise data having a substantially equivalent or greater 321 restricted access level based on business rules or by law, for example using a list, lookup table or other business logic 325 to determine the relative restricted access levels of the proxy data 310a and the confidential data. In such a case, the comparison module 314 can perform either or both of: (i) performing a matching of at least a sufficient portion of the proxy data received 310a with information that is already stored on a server, such as a problem, treatment or medication 322c, to determine that there is a sufficient match, and (ii) consult a list, lookup table or business logic 325 to determine whether the proxy data 310a is of a type that has a substantially equivalent or greater restricted access level to permit access to confidential data 312.

FIG. 4 is a schematic block diagram of a system 400 for access rights determination using proxy data, in communication with an electronic health record or electronic medical record (EHR/EMR) system 426 and a speech recognition system 428, in accordance with an embodiment of the invention. In FIG. 4, the access rights control module 406 is further configured to receive proxy data by receiving an application layer level communication 430 from an EHR/EMR system 426 to determine access rights to the confidential data. Here, the proxy data speech recognition text 424a, and the confidential data is stored by a speech recognition system 428. For example, the confidential data can be audio data comprising speech 422a, and the proxy data assessment module 408 can compare speech recognition text 424b with stored speech recognition text 410a, for example using comparison module 314 (see FIG. 3), to determine whether access should be provided to the audio data 422a based on the proxy data 424a. In one example, the speech recognition system 428 is a server, such as a medical information server, operating the Dragon® Medical Server speech recognition system, sold by Nuance Communications, Inc., of Burlington, Mass., U.S.A.

In accordance with an embodiment of the invention, proxy data can be presented in place of a user credential, using a variety of different possible techniques. For example, application layer communication 430 may present proxy data, such as speech recognition text 424b, using a Hyper Text Transfer Protocol request (HTTP request), or any other means of inter system communication. In some embodiments, only a portion of the proxy data is presented—for example, an identical match with a fraction of the speech recognition text, such as less than a quarter of the text, or less than a tenth of the text, or less than 1% of the text, or another acceptable fraction of the text or other proxy data, may be considered sufficient to grant access. The intersystem communication of the proxy data, such as application layer communication 430, may contain only a link to the proxy data, or another association with the proxy data, rather than a full copy of the proxy data itself. A session cookie may be passed, which may be associated or be linked with the proxy data itself.

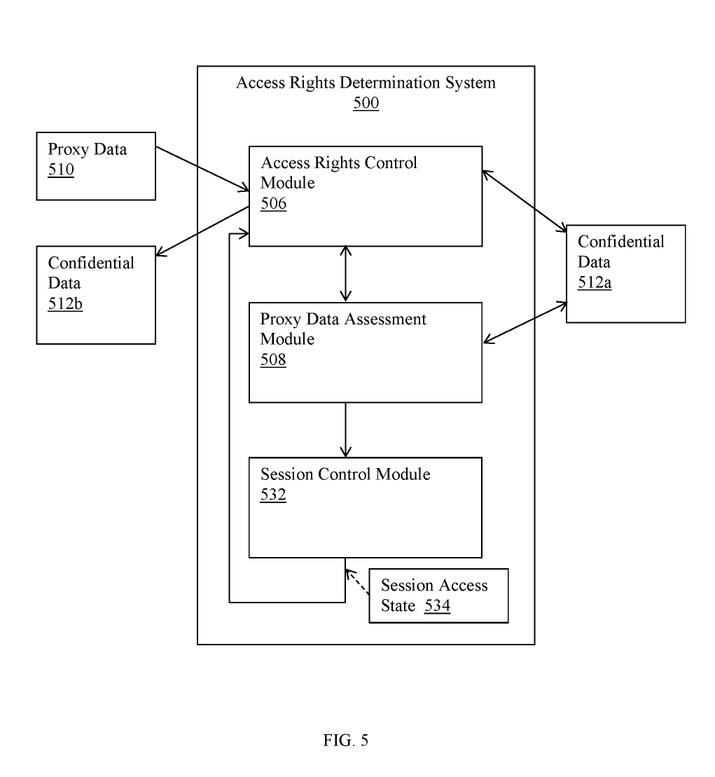

FIG. 5 is a schematic block diagram of a system 500 for access rights determination using proxy data 510, which includes a session control module 532, in accordance with an embodiment of the invention. The system 500 comprises a session control module 532, which is configured, upon the determination by the proxy data assessment module 508 that the proxy data 510 does have an equivalent or greater restricted access level as compared with the restricted access level of the confidential data, to provide rights to the access to the confidential data 512a to a user, for the duration of a session of interaction with the user. For example, access to confidential data 512b may be provided by access rights control module 506 as long as a temporary session access state 534 signifies that such access is authorized by virtue of a session having been properly opened using authorized proxy data as described herein. Once the session is ended, the session access state 534 is deactivated, and access to confidential data 512a/512b will no longer be provided to the user without re-authorization. In one example, a user can provide proxy data as credentials at the beginning of the session, and then, for the duration of the same session with that user, it will be implied that the user has the same access rights that were given at the beginning of the session. A first system can send proxy data to a second system at the beginning of the session as user credentials, and access to the confidential data on the second system can then hold for the duration of a session. The transfer of proxy data can occur as part of a session mode of interaction between the systems: the session is opened, text or other proxy data is provided as user credentials; the user then navigates, plays audio data, revises text, and performs other interactions in the context of the session; and throughout the session, the second system remembers the access rights based on the initial use of proxy data as credentials. Such authorization can be a temporary state within a session, and can, for example, include a time limit under which, if a user does not interact with a system for a set of period of time, the user is locked out of the session.

FIG. 6 is a schematic block diagram of a system 600 for access rights determination using proxy data 610, in communication with first system 636 requiring user credentials and access rights 642, and a second system 638 on which confidential data 612a is stored, in accordance with an embodiment of the invention. The access rights control module 606 is configured to receive the proxy data 610 by receiving an application layer level communication 630 from the first system 636 to a second system 638, different from the first system 636, to determine access rights to the confidential data 612a stored by the second system 638. The proxy data 610 is accessible to a user 640 of the first system 636, based on at least (i) credentials of the user with the first system and (ii) access rights of the user with the first system, 642. The access rights control module 606 is configured, upon the determination by the proxy data assessment module 608 that the proxy data 610 does have an equivalent or greater restricted access level as compared with the restricted access level of the confidential data 612a, to use the proxy data 610 as user credentials to permit the user 640 of the first system 636 to access the confidential data 612a stored by the second system 638.

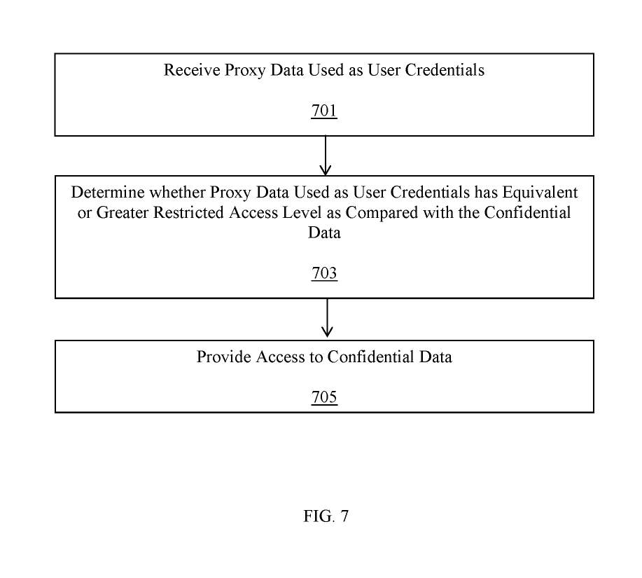

FIG. 7 is a schematic block diagram of a computer-implemented method for access rights determination in accordance with an embodiment of the invention. The method comprises receiving 701 proxy data used as user credentials to access confidential data, where the confidential data has a restricted access level. The method further comprises determining 703 whether the proxy data has an equivalent or greater restricted access level as compared with the restricted access level of the confidential data; and, upon determining that the proxy data does have an equivalent or greater restricted access level as compared with the restricted access level of the confidential data, providing 705 access to the confidential data.

Although the Medical HL7 protocol is referred to herein, other protocols can be used for any information exchanged between systems, using techniques taught herein. In addition, techniques taught herein may be used contexts other than healthcare, and for data other than speech recognition—such as in a corporate, legal or financial context, or in other industries. For example, an embodiment according to the invention can be used to determine access rights to a company's confidential financial information. In such a context, as one example, the restricted access level of some data may require that a company's confidential financial information is accessible to all employees at Director level and above. Other restricted access levels can be used in a variety of contexts.

In an embodiment according to the invention, processes described as being implemented by one processor may be implemented by component processors configured to perform the described processes. Such component processors may be implemented on a single machine, on multiple different machines, in a distributed fashion in a network, or as program module components implemented on any of the foregoing. In addition, systems such as access rights determination systems 200, 400, 500 and 600, and their components, can likewise be implemented on a single machine, on multiple different machines, in a distributed fashion in a network, or as program module components implemented on any of the foregoing. In one example, the access rights determination systems 200, 400, 500 and 600 can be implemented on a first system 636 (see FIG. 6), such as an EHR/EMR system 426 (see FIG. 4); in another example, the access rights determination systems 200, 400, 500 and 600 can be implemented on a second system 638 (see FIG. 6), such as speech recognition system 428 (see FIG. 4); or the access rights determination systems 200, 400, 500 and 600 can be implemented as a separate system between such systems; or in a distributed fashion; or as a system resident in part on each of two or more such systems.

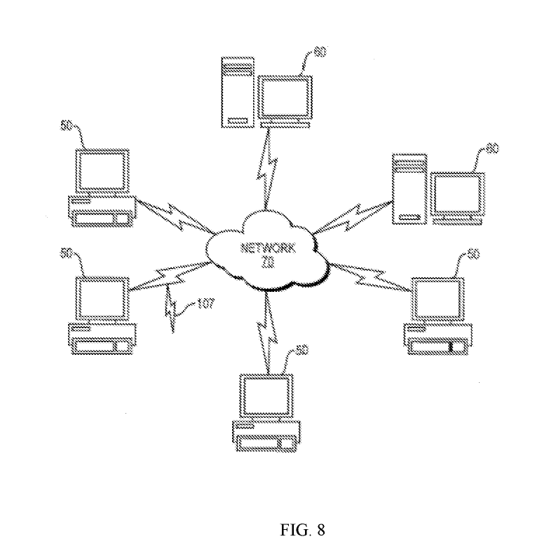

FIG. 8 illustrates a computer network or similar digital processing environment in which embodiments of the present invention may be implemented. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

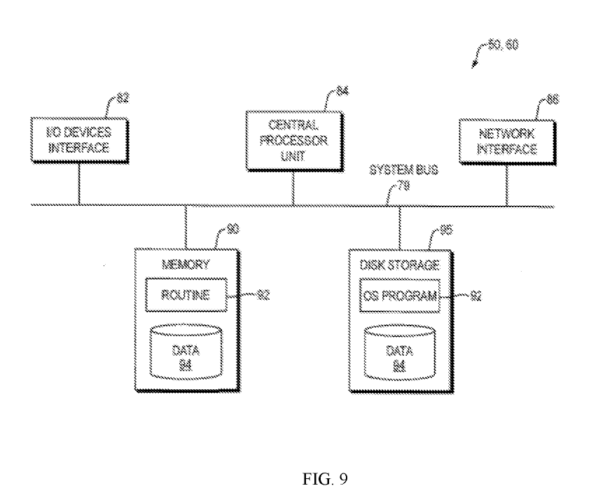

FIG. 9 is a diagram of an example internal structure of a computer (e.g., client processor/device 50 or server computers 60) in the computer system of FIG. 8. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 8). Memory 90 provides volatile storage for computer software instructions 92 and data 94 used to implement an embodiment of the present invention (e.g., access rights control module 206, 406, 506, 606, proxy data assessment module 208, 308, 408, 508, 608, comparison module 314, access determination module 316 and session control module 532, detailed above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92.

In alternative embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer.

While example embodiments have been particularly shown and described, it will be understood by those skilled in the art that various changes in form and details may be made therein without departing from the scope of the embodiments encompassed by the appended claims.

What is claimed is:

1. A computer-implemented method for access rights determination, the computer-implemented method comprising:
receiving proxy data used as user credentials to access confidential data, the confidential data having a restricted access level;
determining whether the proxy data has an equivalent or greater restricted access level as compared with the restricted access level of the confidential data; and
upon determining that the proxy data does have an equivalent or greater restricted access level as compared with the restricted access level of the confidential data, providing access to the confidential data.

2. The computer-implemented method of claim 1, the determining comprising determining whether the proxy data is: (i) substantially equivalent in restricted access level by virtue of being the result of a computer-implemented transformation of the confidential data; or (ii) greater in restricted access level by virtue of being data from which the confidential data is derived by a computer-implemented process; or (iii) substantially equivalent or greater in restricted access level based on business rules or by law.

3. The computer-implemented method of claim 2, wherein the confidential data comprises audio data comprising speech, and the proxy data comprises speech recognition text derived from the audio data.

4. The computer-implemented method of claim 3, wherein the audio data comprises speech comprising personal health information or personal medical information, and the speech recognition text comprises speech recognition data of an electronic health record or electronic medical record, derived from the audio data.

5. The computer-implemented method of claim 4, wherein receiving the proxy data comprises receiving an application layer level communication from an electronic health record system or electronic medical record system to determine access rights to the confidential data, and the confidential data is stored by a speech recognition system.

6. The computer-implemented method of claim 1, wherein the confidential data comprises personal health information or personal medical information, and the proxy data comprises data from which the confidential data is derived by a clinical language understanding engine.

7. The computer-implemented method of claim 1, wherein the confidential data comprises personal health information or personal medical information comprising at least one of: data associated with identification of a medical problem; a medical treatment; and a medication; and
the proxy data comprising (i) sufficient confidential data identifying a person associated with a medical report of the person to permit access to the medical report; and (ii) at least a portion of a text of the medical report of the person that is at an equivalent or greater restricted access level as the confidential data.

8. The computer-implemented method of claim 1, wherein the receiving the proxy data comprises receiving an application layer level communication from a first system to a second system, different from the first system, to determine access rights to the confidential data stored by the second system;
the proxy data being accessible to a user, the user being a user of the first system, based on at least (i) credentials of the user with the first system and (ii) access rights of the user with the first system; and
the providing access to the confidential data comprising using the proxy data as user credentials to permit the user of the first system to access the confidential data stored by the second system.

9. The computer-implemented method of claim 1, further comprising, based on the determining that the proxy data does have an equivalent or greater restricted access level as compared with the restricted access level of the confidential data, providing rights to the access to the confidential data to a user, for the duration of a session of interaction with the user.

10. The computer-implemented method of claim 9, wherein the providing the rights to the access to the confidential data is performed as a temporary state for the duration of the session.

11. A computer system comprising:
a processor; and
a memory with computer code instructions stored thereon, the processor and the memory, with the computer code instructions being configured to implement:
an access rights control module, the access rights control module being configured to receive proxy data used as user credentials to access confidential data, the confidential data having a restricted access level; and
a proxy data assessment module, the proxy data assessment module being configured to determine whether the proxy data has an equivalent or greater restricted access level as compared with the restricted access level of the confidential data;
the access rights control module being further configured, upon a determination by the proxy data assessment module that the proxy data does have an equivalent or greater restricted access level as compared with the restricted access level of the confidential data, to provide access to the confidential data.

12. The computer system of claim 11, wherein the proxy data assessment module is further configured to determine whether the proxy data is: (i) substantially equivalent in restricted access level by virtue of being the result of a computer-implemented transformation of the confidential data; or (ii) greater in restricted access level by virtue of being data from which the confidential data is derived by a computer-implemented process; or (iii) substantially equivalent or greater in restricted access level based on business rules or by law.

13. The computer system of claim 12, wherein the confidential data comprises audio data comprising speech, and the proxy data comprises speech recognition text derived from the audio data;
the proxy data assessment module being further configured to determine whether the proxy data has an equivalent or greater restricted access level as compared with the restricted access level of the confidential data based on confirming whether the proxy data does in fact comprise speech recognition text that is derived from the audio data.

14. The computer system of claim 13, wherein the audio data comprises speech comprising personal health information or personal medical information, and the speech recognition text comprises speech recognition data of an electronic health record or electronic medical record, derived from the audio data.

15. The computer system of claim 14, wherein the access rights control module is further configured to receive the proxy data by receiving an application layer level communication from an electronic health record system or electronic medical record system to determine access rights to the confidential data, and the confidential data is stored by a speech recognition system.

16. The computer system of claim 11, wherein the confidential data comprises personal health information or personal medical information, and the proxy data comprises data from which the confidential data is derived by a clinical language understanding engine;
the proxy data assessment module being further configured to determine whether the proxy data has an equivalent or greater restricted access level as compared with the restricted access level of the confidential data based on confirming whether the proxy data does in fact comprise data from which the confidential data is derived by a clinical language understanding engine.

17. The computer system of claim 11, wherein the confidential data comprises personal health information or personal medical information comprising at least one of: data associated with identification of a medical problem; a medical treatment; and a medication; and
the proxy data comprises: (i) sufficient confidential data identifying a person associated with a medical report of the person to permit access to the medical report; and (ii) at least a portion of a text of the medical report of the person that is at an equivalent or greater restricted access level as the confidential data;
the proxy data assessment module being further configured to determine whether the proxy data has an equivalent or greater restricted access level as compared with the restricted access level of the confidential data based on confirming whether the proxy data does in fact comprise: (i) sufficient confidential data identifying a person associated with a medical report of the person to permit access to the medical report; and (ii) text of the medical report of the person.

18. The computer system of claim 11, wherein the access rights control module is further configured to receive the proxy data by receiving an application layer level communication from a first system to a second system, different from the first system, to determine access rights to the confidential data stored by the second system;
the proxy data being accessible to a user, the user being a user of the first system, based on at least (i) credentials of the user with the first system and (ii) access rights of the user with the first system; and
the access rights control module being further configured, upon the determination by the proxy data assessment module that the proxy data does have an equivalent or greater restricted access level as compared with the restricted access level of the confidential data, to use the proxy data as user credentials to permit the user of the first system to access the confidential data stored by the second system.

19. The computer system of claim 11, wherein the system comprises a session control module, the session control module being configured, upon the determination by the proxy data assessment module that the proxy data does have an equivalent or greater restricted access level as compared with the restricted access level of the confidential data, to provide rights to the access to the confidential data to a user, for the duration of a session of interaction with the user.

20. A non-transitory computer-readable medium configured to store instructions for access rights determination, the instructions, when loaded and executed by a processor, cause the processor to determine access rights by:
receiving proxy data used as user credentials to access confidential data, the confidential data having a restricted access level;
determining whether the proxy data has an equivalent or greater restricted access level as compared with the restricted access level of the confidential data; and
upon determining that the proxy data does have an equivalent or greater restricted access level as compared with the restricted access level of the confidential data, providing access to the confidential data.
